(19) United States
(12) Patent Application Publication
(10) Pub. No.: US 2004/0264885 A1
(43) Pub. Date: Dec. 30, 2004

(54) Method for production of an optical housing, optical housing and opto-electronic device

(76) Inventor: Fabrice Serafin, Grenoble (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 10/471,780

(22) PCT Filed: Mar. 6, 2002
(86) PCT No.: PCT/FR02/00809

(30) Foreign Application Priority Data
Mar. 15, 2001 (FR) 01/03544

(51) Int. Cl. G02B 6/36

(52) U.S. Cl. 385/92

(57) ABSTRACT

The invention relates to a method for the production of an optical housing and an optical housing comprising at least one integrated optical component, provided with electrical contacts and at least one optical fibre, connected to said optical component, whereby a unit (2) has fixed electrical terminals (8), a support plate (3) with said optical component (4) fixed thereto, the connections (5) of said optical component (4) are connected to said terminal (8) and said optical fibre (6) is coupled to said optical component (4). Said unit (2) is at least partly encapsulated by suitable means such as to permit a part of each terminal to extend to the exterior and to support a part of the extremity of said optical fibre. The invention further relates to an opto-electronic device, comprising the optical housing (1) above and an electrical housing, comprising means for electrical connection (23) coupled to said electrical connection terminals (8) of said optical box.

The present invention relates to the field of the packaging of integrated optical components and to the use of such packages.

In general, optical components of integrated structure may be produced so as to fulfill, for example, the functions of switching, routing, multiplexing, demultiplexing, amplifying or attenuating optical waves between input and output optical fibers.

The integrated optical components, produced more particularly in the form of structures made of semiconductor materials, must be mounted in packages so as to be able to be used without any special precaution. In general, such optical components are optically coupled to optical fibers and they have electrical contact pads.

At the present time, a package is known that is composed of a box provided with an adhesively bonded lid, the optical component being installed in the box. The optical fibers connected to this component pass through the wall of the box and a multicontact connector for external electrical connection is fixed through the wall of the box and is electrically connected to the electrical contact pads of the optical component via electrical wires. Furthermore, the box is filled with an optical liquid.

Such an arrangement poses manufacturing difficulties, especially as regards the mounting of the optical fibers, of the electrical connection wires and of the multicontact connector, and it does not allow the desired sealing to be achieved in a reliable manner.

The object of the present invention is especially to obtain an optical package that can be manufactured and used more easily.

The subject of the present invention is firstly a method for manufacture of an optical package comprising at least one integrated optical component provided with electrical contact pads and at least one optical fiber connected to this optical component.

The method according to the invention includes, so as to produce an assembly, mounting electrical contact pins in holes of a support plate, fixing said optical component to one face of said support plate, electrically connecting said pads of said optical component to said pins, and optically coupling said optical fiber to said optical component.

The method according to the invention includes at least partly encapsulating said assembly in such a way that an end part of each pin extends to the outside and an end part of said optical fiber is held in place.

The method according to the invention may advantageously include providing a cavity in which said optical component lies and filling this cavity with an optical liquid.

The method according to the invention preferably includes installing said assembly in a tray-shaped box, one sidewall of which has at least one notch in a position such that said optical component is placed so as to face the top of this box and such that said optical fiber passes through said notch and depositing an encapsulating material at least between, on the one hand, the periphery of said support plate and around said optical fiber and, on the other hand, the sidewalls of said box.

The method according to the invention may advantageously include installing said assembly in a tray-shaped box, one sidewall of which has at least one notch, in a position such that said optical component is placed so as to face the top of this box and such that said optical fiber passes through said notch, depositing an encapsulating material at least between the perimeter of said fiber and corresponding sidewall of said box, filling the cavity formed between said support plate and the top of said box with an optical liquid, and depositing an encapsulating material at least between the periphery of said support plate and the sidewalls of said box.

The method according to the invention may advantageously include covering said support plate with an encapsulating material.

The method according to the invention may advantageously include electrically connecting said pads to said pins via electrical wires.

The subject of the present invention is also an optical package.

According to the invention, this package includes an assembly including at least one integrated optical component having electrical contact pads, a support plate to one face of which said optical component is fixed, electrical connection pins fixed in the holes of said support plate, electrical connection means that couple said pins to said pads of said optical component, and at least one optical fiber, one end of which is optically coupled to said optical component.

According to the invention, the package furthermore includes means for encapsulating at least part of said assembly such that an end part of said pins extends to the outside and such that an end part of said optical fiber is held in place.

According to the invention, said encapsulation means comprise a tray-shaped box in which said support plate is laid flat, one sidewall of the box has a notch for the passage of said optical fiber, and an encapsulating material that extends at least between, on the one hand, the periphery of said support plate and around said fiber and, on the other hand, the sidewalls of said box.

According to the invention, said support plate preferably includes a notch located near the notch in said box.

According to the invention, said box preferably includes an internal partition that defines a space located near the notch in said box.

According to the invention, said optical fiber preferably carries a sleeve that extends through the notch in said box.

According to the invention, said encapsulating material preferably covers said support plate.

According to the invention, said optical component is preferably supported by said support plate so as to face the top of said box, and said pins extend to the outside so as to face the opening of this box.

According to the invention, the cavity that separates said support plate from the top of said box is preferably filled with an optical liquid.

According to the invention, said support plate preferably includes at least one through-hole.

According to the invention, said electrical connection means comprise electrical wires that connect said pads of said optical component to said pins.

The subject of the present invention is also an optoelectronic device.

This optoelectronic device includes the aforementioned optical package and an electronic package that preferably includes electrical connection means suitable for being coupled to the external parts of the electrical connection pins of said optical package, this electronic package preferably including external electrical connection means.

The present invention will be more clearly understood on examining an optical package, its method of manufacture and an optoelectronic device, these being described by way of non-limiting examples and illustrated by the drawing in which:

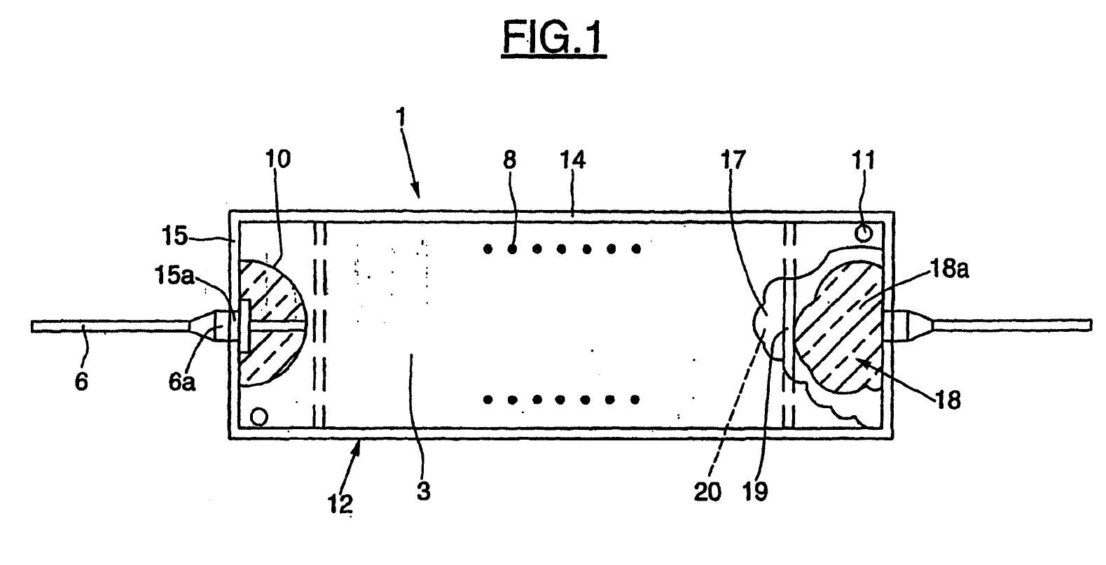

FIG. 1 shows a view from above of an optical package according to the present invention, in the course of being manufactured;

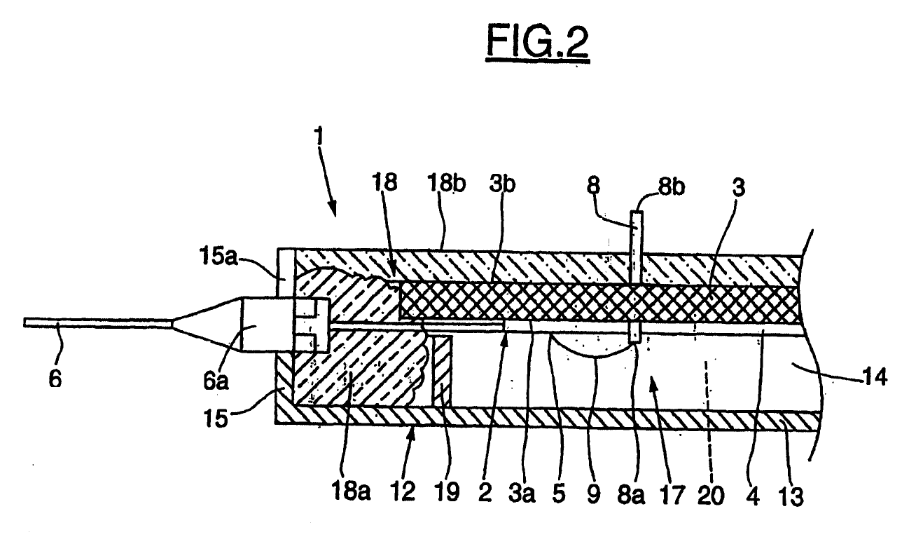

FIG. 2 shows a longitudinal section on 11-11 of an end part of the optical package of FIG. 1, at the end of manufacture;

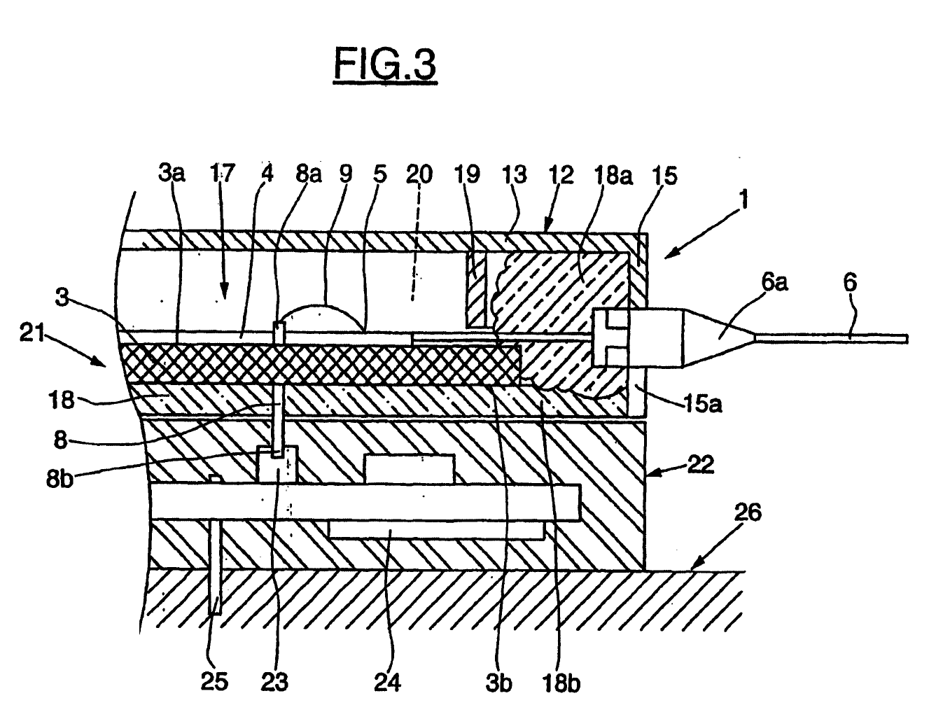

FIG. 3 shows a longitudinal section of an end part of an optoelectronic device that includes the aforementioned optical package; and

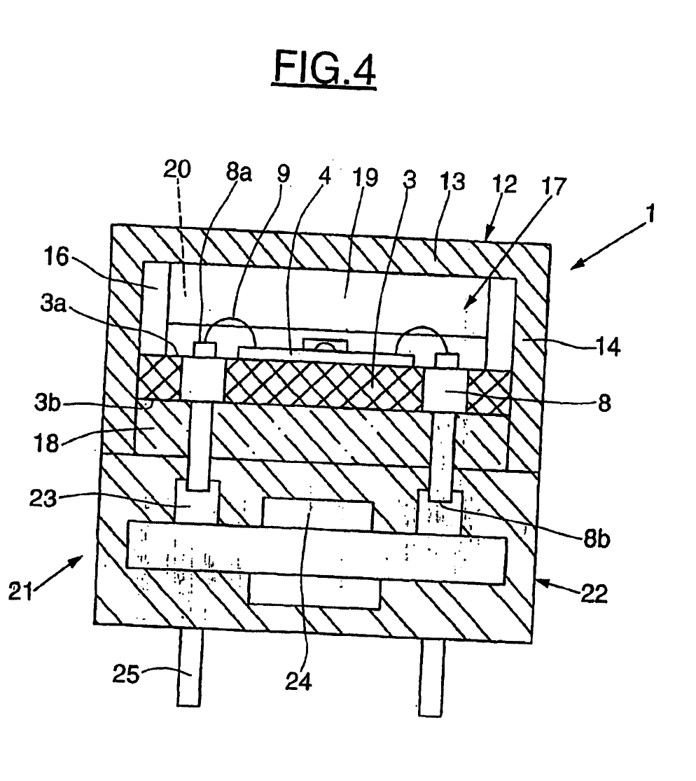

FIG. 4 shows a cross section of the optoelectronic device of FIG. 3.

The optical package 1 shown in the figures comprises an assembly 2 that includes a support plate 3 of rectangular shape, made of an electrically nonconducting material, to one face 3a of which is fixed, for example by adhesive bonding, a flat integrated optical component 4, this component 4 being provided, on its face on the opposite side from the plate 3, with electrical contact pads 5. The assembly 2 also includes two optical fibers 6 optically coupled to the optical component 4 near its transverse ends in such a way that the optical fibers 6 can lie longitudinally opposite each other.

The optical fibers 6 are provided with sleeves 6a.

The support plate 3 has through-holes 7 into which electrical connection pins 8 are fitted, these pins 8 lying perpendicular to the support plate 3.

The electrical contact pads 5 of the optical component 4 and those ends 8a of the pins 8 lying on the same side as the support plate 3 are connected via electrical wires 9.

Near the longitudinal optical fibers 6, the support plate 3 has notches 10 that open longitudinally.

In two of its opposed corners, the support plate 3 has through-holes 11 of small cross section.

The package 1 comprises a tray-shaped box 12, of parallelepipedal shape, having a top 13, two longitudinal sidewalls 14 and two transverse sidewalls 15 in which notches 15a are provided, the distances between the longitudinal sidewalls 14 and the transverse sidewalls 15 corresponding to the width and to the length of the support plate 3.

The assembly 2 described above is placed in the box 12 in the following manner.

The support plate 3 lies parallel to and some distance from its top 13 forming a cavity 17, in a position such that the optical component 4 and the electrical wires 9 are placed in this cavity 17. The sleeves 6a carried by the optical fibers 6 are engaged in the notches 15a of the transverse sidewalls 15 of the box 12 and are partly engaged in the end notches of the support plate 3.

In the example shown, the support plate presses against feet 16 provided in the box 12. In a variant, the support plate 3 could be held in place in the aforementioned position thanks to inward deformations of the longitudinal walls 14 of the box 12.

The package 1 furthermore includes an electrically nonconducting encapsulating material 18, such as an epoxy resin, which is placed in the box 12. This encapsulating material 18 surrounds the internal part of the sleeves 6a and part of the optical fibers 6, embedding these fibers in the notches 10 of the support plate 3 as far as the transverse sidewalls 15 of the box 3, and fills the volume lying between the face 3b of the support plate 3 opposite to the cavity 17, as far as the edges of the sidewalls 14 and 15 of the box 12.

The electrical connection pins 8 are of a length such that they have end parts 8b that lie outside the encapsulating material 18 deposited.

Thus, on the one hand, the optical fibers 6 and their sleeves 6a are held in place near the notches 15a of the cavity 12 and the support plate 3 is held in place and, on the other hand, the cavity 17 is sealed from the outside. This is because the encapsulating material 18 provides an impermeable connection, on the one hand, between the optical fibers 6 and more particularly the sleeves 6a and the internal faces of the transverse sidewalls of the box 12 and, on the other hand, the peripheral edge of the support plate 3 and the internal faces of the sidewalls 14 and 15 of the box 12, the encapsulating material 18 also sealing between the pins 8 and the support plate 3.

Moreover, the box 12 is provided with internal partitions 19 that extend from its top 12, some distance from its transverse sidewalls 15, and are inwardly offset relative to the end notches 10 of the support plate 3.

Finally, the cavity 17 of the optical package 1 may be filled with an electrically nonconducting optical liquid 20, for example a silicone oil that completely embeds the optical component 4 so as to fill the cavities or interstices of this optical component, which provide an optical function.

To manufacture the optical package 5 that has been described, the procedure may be as follows.

Firstly, the assembly 2 described above is prefabricated.

Next, this prefabricated assembly 2 is installed in the box 12 as described above, by bringing the support plate 3 so as to bear on the feet 16 and by engaging the sleeves 6a of the optical fibers 6 in the notches 15a of the transverse sidewalls 15 of the box 12.

A quantity 18a of the encapsulating material 18 is then deposited around the sleeves 6, against the internal faces of the sidewalls 15 of the box 12 through the end notches 10 of the support plate 3, the internal partitions 19 of the box 12 preventing the encapsulating material from spreading into the cavity 17. In a variant, it will also be possible to deposit a spot of encapsulating material in the corners formed between the support plate 3 and the sidewalls 14 and 15 of the box 12.

Next, the cavity 17 is filled with the optical liquid 20 via one of the holes 11 in the support plate 3.

Next, having preferably obstructed the holes 11 in the support plate 3, for example with pads (not shown), after the cavity 17 has been filled, a quantity 18b of the encapsulating material 18 is deposited so as to fill the volume lying between the face 3b of the support plate 3 and the plane of the edges of the sidewalls 14 and 15 of the box 12.

Thus, a compact sealed optical package 1 is obtained that is especially strong as regards retention of the optical fibers 6 and is capable of being easily connected to another member by means of the pins 8.

Referring to FIGS. 3 and 4, these show an optoelectronic device 21 that includes the optical package 1 described above, to which an electronic package 22 is coupled.

This electronic package 22 includes electrical connection members 23, into which the end parts 8b of the electrical connection pins 8 of the optical package 1 are engaged or plugged, electronic circuits 24 and, opposite the electrical connection members 23, external connection pins 25 for the purpose of connection, for example, to a motherboard 26, these electronic circuits providing, for example, electronic control of the optical package 1.

Thus, an optoelectronic device 21 is obtained that comprises an optical package 1 and an electronic package 22 that are electrically connected and stacked directly via the pins 8 in such a way that they can be easily coupled and uncoupled and are interchangeable.

The present invention is not limited to the examples described above. Many alternative embodiments are possible without departing from the scope defined by the appended claims.

1. A method for of manufacturing an optical package comprising at least one integrated optical component provided with electrical contact pads and at least one optical fiber connected to this optical component, the method comprising:
mounting electrical contact pins in holes of a support plate;
fixing said optical component to one face of said support plate;
electrically connecting said pads of said optical component to said pins;
optically coupling said optical fiber to said optical component; and at least partly encapsulating said assembly in such a way that an end part of each pin extends to the outside and an end part of said optical fiber is held in place.

2. The method of claim 1, further comprising providing a cavity in which said optical component lies; and filling this cavity with an optical liquid.

3. The method of claim 1, further comprising:
installing said assembly in a tray-shaped box, one sidewall of which has at least one notch in a position such that said optical component is placed so as to face the top of this box and such that said optical fiber passes through said notch; and
depositing an encapsulating material at least between, on the one hand, the periphery of said support plate and around said optical fiber and, on the other hand, the sidewalls of said box.

4. The method of claim 1, further comprising installing said assembly in a tray-shaped box, one sidewall of which has at least one notch, in a position such that said optical component is placed so as to face the top of this box and such that said optical fiber passes through said notch;
depositing an encapsulating material at least between the perimeter of said optical fiber and corresponding sidewall of said box;
filling the cavity formed between said support plate and the top of said box with an optical liquid; and
depositing an encapsulating material at least between the periphery of said support plate and the sidewalls of said box.

5. The method of claim 3, further comprising covering said support plate with an encapsulating material.

6. The method of claim 1, further comprising electrically connecting said pads to said pins via electrical wires.

7. An optical package, comprising an assembly, the assembly comprising:
at least one integrated optical component having electrical contact pads;
a support plate to one face of which said optical component is fixed;
electrical connection pins fixed in the holes of said support plate;
electrical connection means that connect said pins to said pads of said optical component; and
at least one optical fiber, one end of which is optically coupled to said optical component;
and wherein the optical package further comprises:
means for encapsulating at least part of said assembly such that an end part of said pins extends to the outside and such that an end part of said optical fiber is held in place.

8. The optical package of claim 7, wherein said encapsulation means comprise a tray-shaped box in which said support plate is laid flat, one sidewall of which box has a notch for the passage of said optical fiber, and an encapsulating material that extends at least between, on the one hand, the periphery of said support plate and around said fiber and, on the other hand, the sidewalls of said box.

9. The optical package of claim 8, wherein said support plate includes a notch located near the notch in said box.

10. The optical package of claim 8, wherein said box includes an internal partition that defines a space located near the notch in its sidewall.

11. The optical package of claim 8, wherein said optical fiber carries a sleeve that extends through the notch in said box.

12. The optical package of claim 8, wherein said encapsulating material covers said support plate.

13. The optical package of claim 8, wherein said optical component is supported by said support plate so as to face the top of said box, and in that said pins extend to the outside so as to face the opening of this box.

14. The optical package of claim 8, wherein the cavity that separates said support plate from the top of said box is filled with an optical liquid.

15. The optical package of claim 8, wherein said support plate includes at least one through-hole.

16. The optical package of claim 7, wherein said electrical connection means comprise electrical wires that connect said pads of said optical component to said pins.

17. (Cancelled)

18. An optoelectronic device, comprising:
an optical package, the optical package comprising an assembly, the assembly comprising:
at least one integrated optical component having electrical contact pads;
a support plate to one face of which said optical component is fixed;
electrical connection pins fixed in the holes of said support plate;
electrical connection means that connect said pins to said pads of said optical component; and
at least one optical fiber, one end of which is optically coupled to said optical component;
wherein the optical package further comprises means for encapsulating at least part of said assembly such that an end part of said pins extends to the outside and such that an end part of said optical fiber is held in place; and
an electronic package that includes electrical connection means suitable for being coupled to the external parts of the electrical connection pins of said optical package, this electronic package including external electrical connection means.
